(19) United States
(12) Patent Application Publication
(10) Pub. No.: US 2021/0291996 A1
(43) Pub. Date: Sep. 23, 2021

(54) ELECTRIC AIRCRAFT WITH POD MOUNTED BATTERIES

(71) Applicants: Marinus Bernard Bosma, Tipp City, OH (US); Chip West Erwin, Brandon, FL (US)

(72) Inventors: Marinus Bernard Bosma, Tipp City, OH (US); Chip West Erwin, Brandon, FL (US)

(21) Appl. No.: 16/973,644

(22) PCT Filed: Jun. 13, 2019
(86) PCT No.: PCT/US19/37087

§ 371 Date: Dec. 9, 2020

Related U.S. Application Data
(60) Provisional application No. 62/686,001, filed on Jun. 16, 2018.

(51) Int. Cl. B64D 27/24; B60L 50/60; B64D 31/00; B64D 17/78; B64C 11/28; B64D 1/08

(52) U.S. Cl. CPC B64D 27/24; B60L 50/66; B64D 31/00; B64D 2027/026; B64C 11/28; B64D 1/08; B60L 2200/10; B64D 17/78

(57) ABSTRACT

An aircraft has a frame, at least one electrically-powered propulsion unit providing motive power for levitation and translation of the aircraft, at least one pod comprising a battery, mounted by a physical interface to the frame, the physical interface operable to detach and jettison the at last one pod, and comprising electrical connectors coupling the battery in the mounted pod to the at least one electrically-powered propulsion unit, and control circuitry operable to manage power from the battery to the electrically-powered propulsion unit, and to jettison the pod.

### CROSS-REFERENCE TO RELATED APPLICATIONS

The present application claims priority to Provisional Application U.S. 62/686,001, filed Jun. 16, 2018. All disclosure of the parent application is incorporated herein at least by reference.

### BACKGROUND OF THE INVENTION

### 1. Field of the Invention

The present invention is in the technical area of aircraft, relates to an electrical aircraft with wing-mounted pods and, more particularly, to an aircraft with pods that can be jettisoned from the aircraft.

### 2. Description of Related Art

Electrically-powered aircraft are gaining in popularity as motors and batteries become more efficient. However, efficient batteries use aggressive chemistries that are dangerous by themselves but even more so when they catch fire. Possible solutions include shielding the batteries in fireproof enclosures, designing batteries that don't catch fire, creating cooling systems that keep batteries cool, encapsulating each battery cell to prevent one battery from catching other batteries on fire.

Shielding, however, is heavy, and limits access to batteries. Also, batteries that don't catch fire are typically heavy and inefficient. Further, cooling systems take up valuable space, create drag and add weight. Also, encapsulating battery cells also adds weight and cost.

### BRIEF SUMMARY OF THE INVENTION

In one embodiment of the present invention an aircraft is provided, comprising an airframe, at least one electrically-powered propulsion unit providing motive power for levitation and translation of the aircraft, at least one pod comprising a battery, mounted by a physical interface to the airframe, the physical interface operable to detach and jettison the at least one pod, and comprising electrical connectors coupling the battery in the mounted pod to the at least one electrically-powered propulsion unit, and control circuitry operable to manage power from the battery to the electrically-powered propulsion unit, and to jettison the pod.

In one embodiment the at least one pod comprises, in addition to the battery, local control circuitry, an electric motor and a propeller coupled to the motor such that, when the motor operates, the propeller spins. Also, in one embodiment the propeller is enabled to fold into a volume having an axis co-linear with an axis of the motor. In one embodiment the propeller is enabled to vary pitch. And in one embodiment the aircraft is a fixed-wing aircraft, and pods are mounted beneath wings of the aircraft.

In one the pods mounted beneath the wings comprise controls, motors, and propellers, and are manageable through the control circuitry, individually, to start and stop the motors, fold the propellers, and to jettison the pods. Also, in one embodiment the pods further comprise each a parachute controllable to deploy following jettisoning the pod. In one embodiment the fixed-wing aircraft further comprises an electrically-powered motor with propeller separate from the pods, powered from one of more of the pods. And in one embodiment the fixed-wing aircraft further comprises an internal combustion engine with propeller which is enabled to be stopped and feathered with pods powering motors with propellers in operation.

### BRIEF DESCRIPTION OF THE SEVERAL VIEWS OF THE DRAWINGS

FIG. 1 is a perspective view of an aircraft with pod-mounted batteries, controllers, motors, engine and propeller in an embodiment of the present invention.

FIG. 2 is a left perspective view of the aircraft of FIG. 1, with pod-mounted batteries, controllers, motors, engine and propeller.

FIG. 3 is a left perspective view of the aircraft of FIGS. 1 and 2 with pod-mounted batteries, controllers, motors and propeller with propellers hidden to show they are optional, in an embodiment of the invention.

FIG. 4 is a left perspective view of an aircraft with pod-mounted batteries, controllers, motors and a self-folding propeller in an embodiment of the invention.

FIG. 5 is a top view of the aircraft of FIG. 4 with pod-mounted batteries, controllers, motors and self-folding propeller.

FIG. 6 is a top view of the aircraft of FIGS. 4 and 5 with pod-mounted batteries, controller, motor and self-folding propeller deployed in an embodiment of the invention.

FIG. 7 is a top view of an electrically-powered aircraft with jettisonable, pod-mounted batteries in an embodiment of the invention.

FIG. 8 is a rear perspective view of the aircraft of FIG. 7 with jettisonable, pod-mounted batteries.

FIG. 9 is a front perspective view of the aircraft of FIGS. 7 and 8 with jettisonable, pod-mounted batteries.

FIG. 10 is a front perspective view of an aircraft with jettisonable, pod-mounted batteries with a left pod falling away from the wing after being jettisoned.

FIG. 11 is a front view of an aircraft with pod-mounted batteries, controllers, motors, engine and propellers.

FIG. 12 is a front view of an aircraft with pod-mounted batteries, controllers and front mounted motor.

FIG. 13A is a perspective view of a pod.

FIG. 13B is a side view of a pod with batteries, controller, motor and self-folding propeller.

FIG. 14A is a perspective view of a pod.

FIG. 14B is a front view of the pod of FIG. 14A.

FIG. 14C is a section view of the pod of FIGS. 14A and B.

### DETAILED DESCRIPTION OF THE INVENTION

The present invention solves or alleviates a number of problems in the art of aircraft powered by electric motors, necessarily powered by one or more batteries mounted in or on the aircraft. One problem in such aircraft is to have an efficient way to discard or replace batteries that have been drained of power. Another potential problem is that high-power batteries for such application are known to be prone to overheating and fire. It would further be advantageous to provide a way to discard power controllers that may also catch fire. Swapping dead batteries for charged batteries is also a desire.

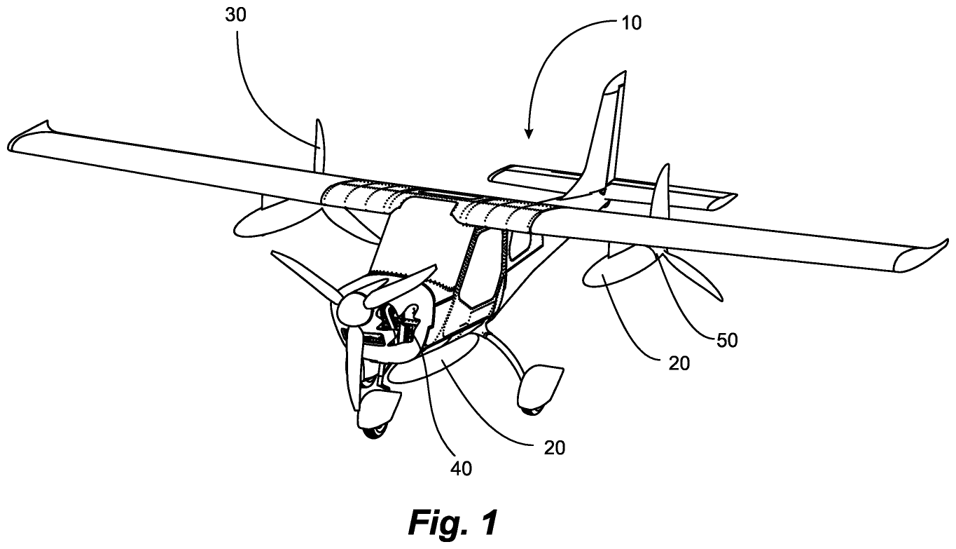

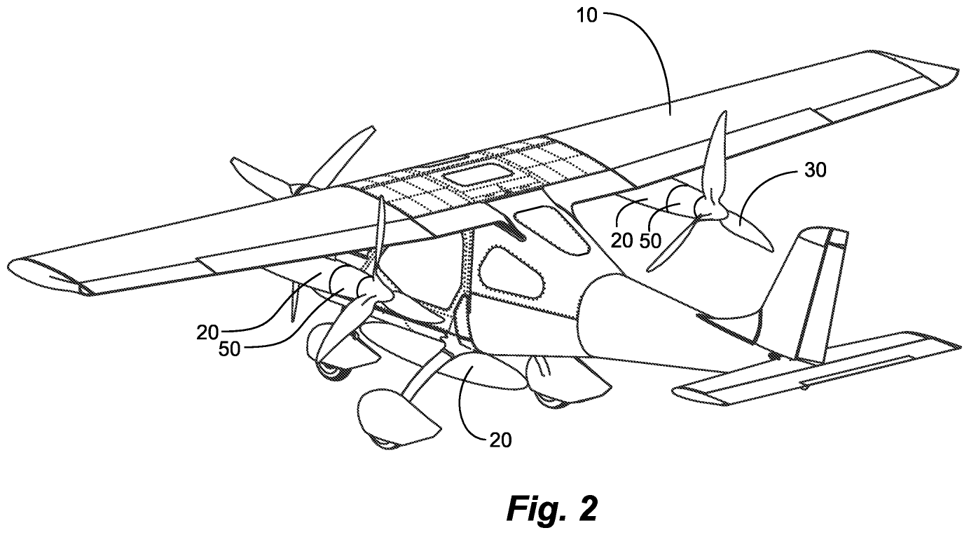

FIG. 1 is a perspective view of an aircraft 10 with three pods 20 mounted thereon, each pod in this example comprising batteries and controllers, and optionally electric motors driving propellers. There are electric motors 50 integrated with pods 20 in this example, and a front-facing engine 40, which may be electric, or may be internal combustion in some embodiments. Both the front-facing engine and the pod motors 50 may drive propellers 30. In embodiments of this invention the aircraft may be powered selectively by the pods, by the front-facing engine, or by both together. FIG. 2 is a left perspective view of aircraft 10 of FIG. 1 with pods 20 including batteries and controllers, and motors 50 at least in two of the pods driving propellers 30.

The pod 20 that is carried under the aircraft fuselage in this example has no motor or propeller. This pod may be just auxiliary power source supplementing the other pods. In embodiments of the invention there are physical interface under the wings and under the fuselage comprising also electrical connectors and conductors, such that each pod location may be connected with others so that any pod may be a power source for electrical motors in other pod locations. In some embodiments, as described above, computerized controllers are incorporated within the pods, and control connections may also be made through the physical interfaces where pods are supported. There may be control circuitry within the cockpit of the aircraft whereby a pilot or other person may manage functionality of pods, including releasing pods, as described further below.

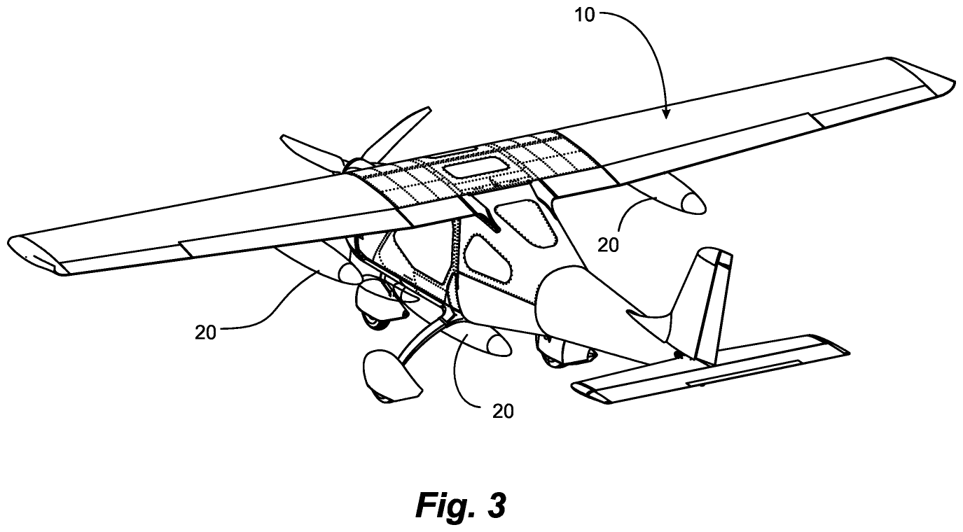

FIG. 3 is a left perspective view of an aircraft 10 with pods 20 shown without propellers, to indicate that in some embodiment the pods may be basically power supplies, and in other embodiments, the pods may have motors with controllers, the motors driving propellers.

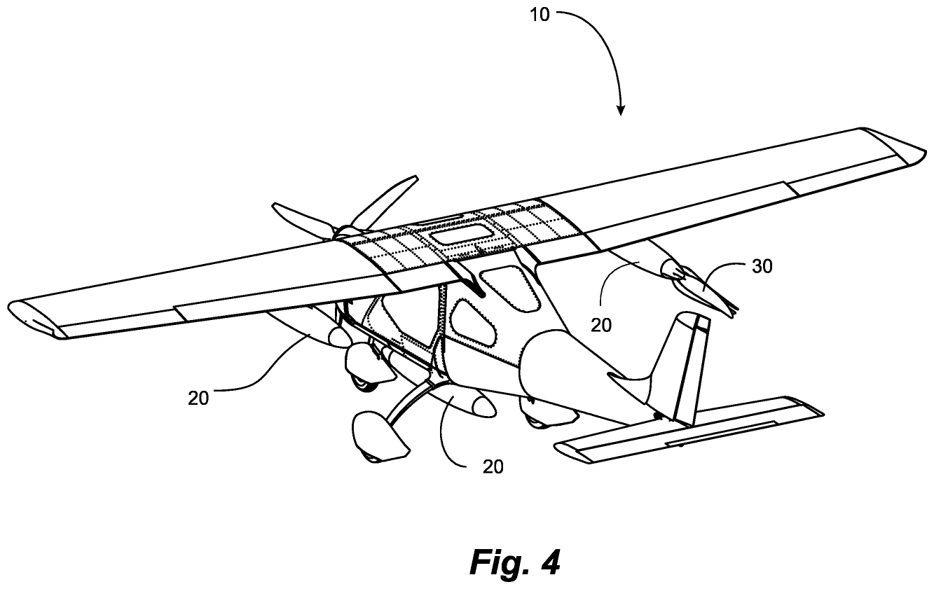

FIG. 4 is a left perspective view of an aircraft 10 with pods 20 having batteries, controllers, motors 50 and self-folding propellers. The self-folding propeller is shown on just one pod 20, but in embodiments of the invention there may be more than one such propeller. Propellers in some embodiments are enabled to fold to provide a small package, as in some embodiments the pods may be ejected with parachutes, and leaving the propellers deployed may be an invitation to damage. Another advantage of folding propellers is that, when a pod is not employed for driving the propeller, the folded propeller provides reduced drag.

In one embodiment the propellers on the pods are opposite hand, chiral orientation and counter-rotating. The advantage to counter-rotating propellers when attached to the wing is you don't have a “critical” motor. By rotating “into” the fuselage the torque of the motor doesn't tend to roll the aircraft on its back.

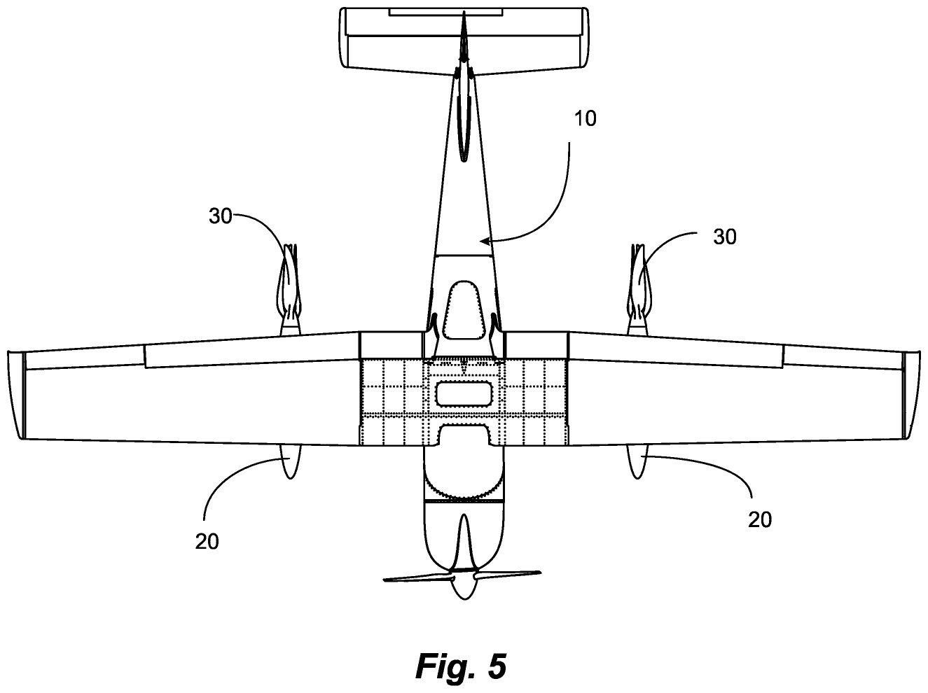

FIG. 5 is a top view of an aircraft 10 with pods 20 having batteries, controllers, motors 50 and folding propellers. In FIG. 5 both pods shown mounted under the wings of the aircraft are shown with folding propellers.

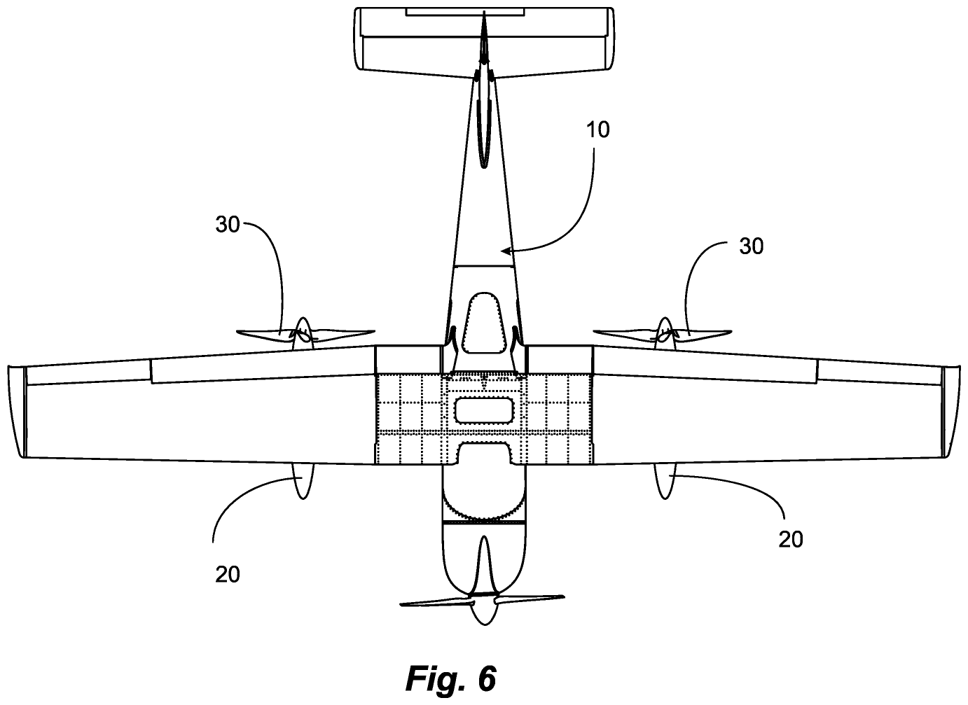

FIG. 6 is a top view of an aircraft 10 of FIG. 5 with pods 20 having batteries, controllers, motors 50 and self-folding propellers, with the propellers deployed.

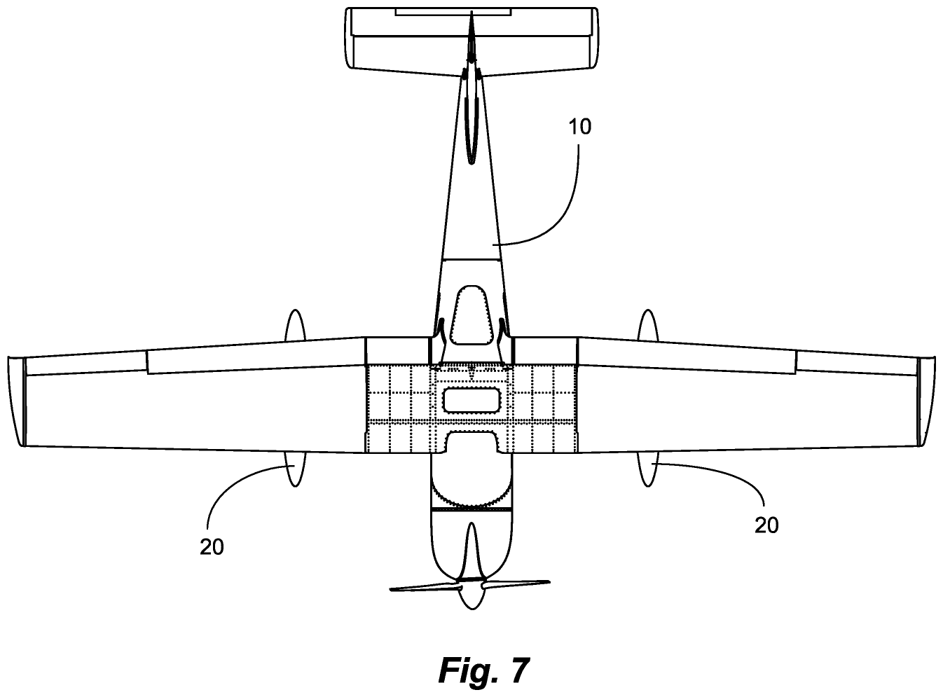

FIG. 7 is a left perspective view of an electrical aircraft 10 with jettisonable pods 20. In this implementation the pods are attached by a physical interface under the aircraft wing or the fuselage, with elements that may be remotely controlled to release and drop the pod. The action may in some embodiments by manually controllable from control circuitry having an interactive interface in the aircraft cockpit, or in some cases may be automatically triggered by any one of several conditions, such as fire in a pod, overheating, power depletion and so on In some embodiments there may be a mechanical latch that unlatches to allow the pod to fall from the aircraft.

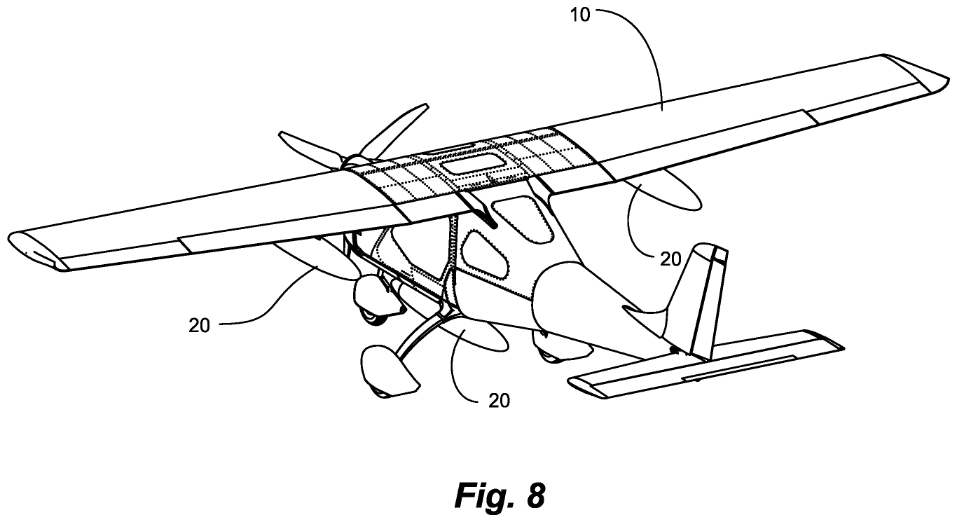

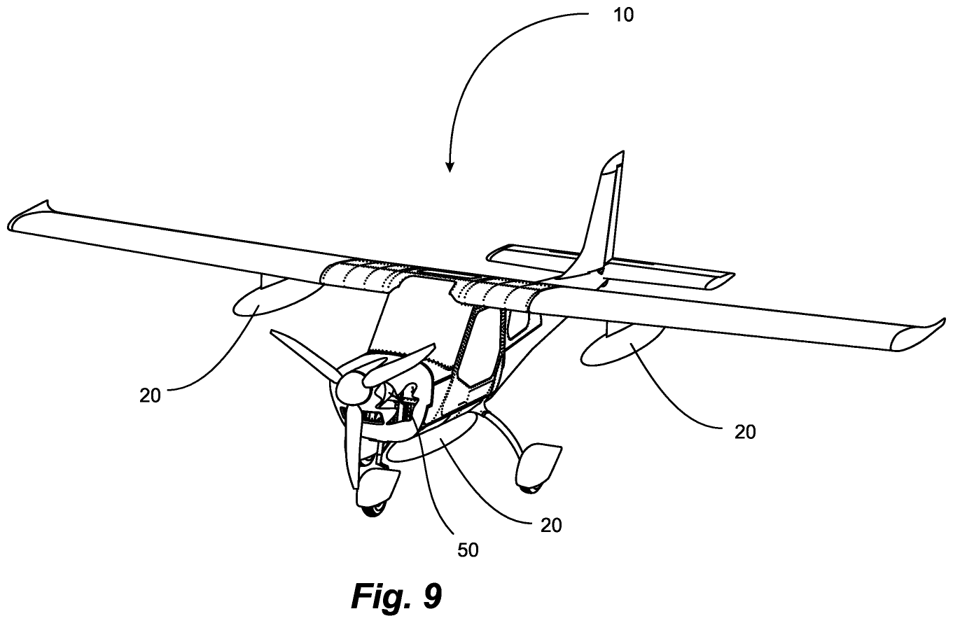

FIG. 8 is a rear perspective view of an electrical aircraft 10 with jettisonable, pods 20, and FIG. 9 is a front perspective view of an electrical aircraft 10 with jettisonable, pods 20.

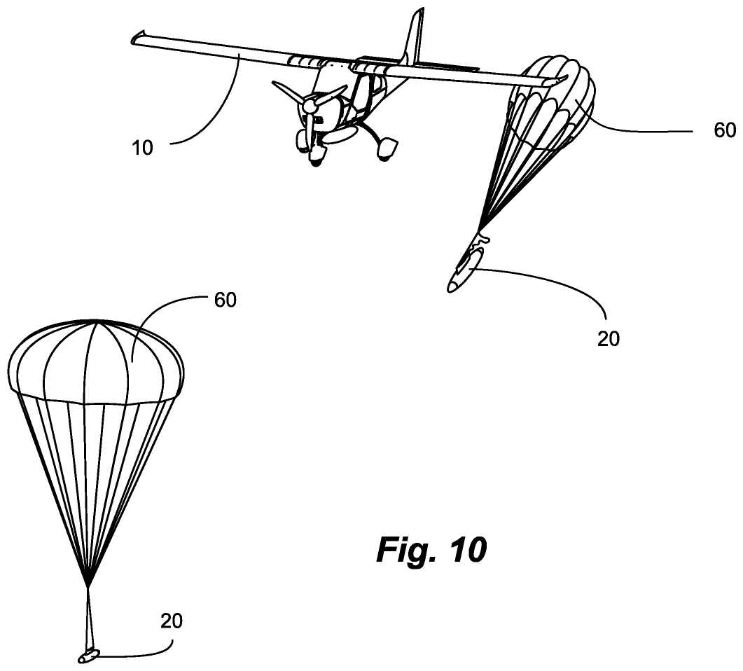

FIG. 10 is a front perspective view of an electrical aircraft 10 with jettisonable, pods 20 in process of jettisoning the pods. The right pod has been jettisoned first, has deployed a parachute 60, and the left pod 20 is shown falling away from the wing after being jettisoned. The deployment of the parachute is in most embodiments automatic after the release mechanism has been activated.

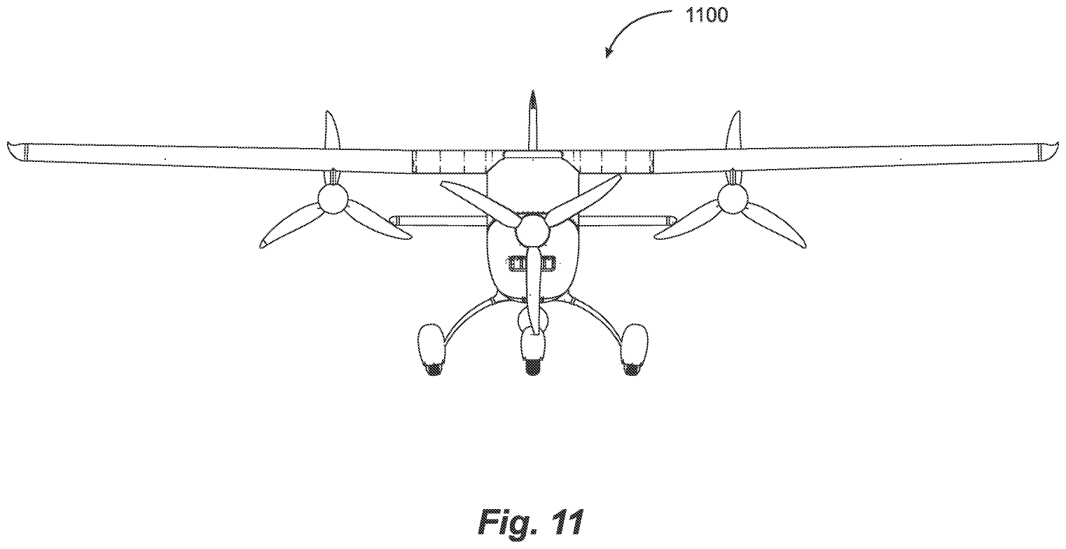

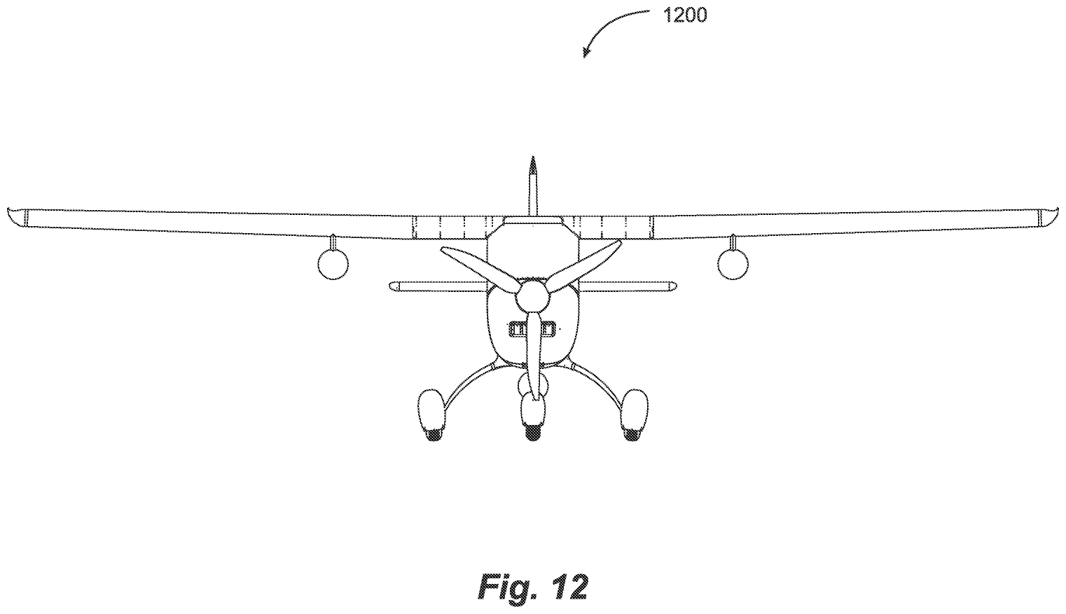

FIG. 11 is a front view of an aircraft 1100 with pod-mounted batteries, controllers, motors, engine and propellers. FIG. 12 is a front view of an aircraft 1200 with pod-mounted batteries, controllers and front mounted motor.

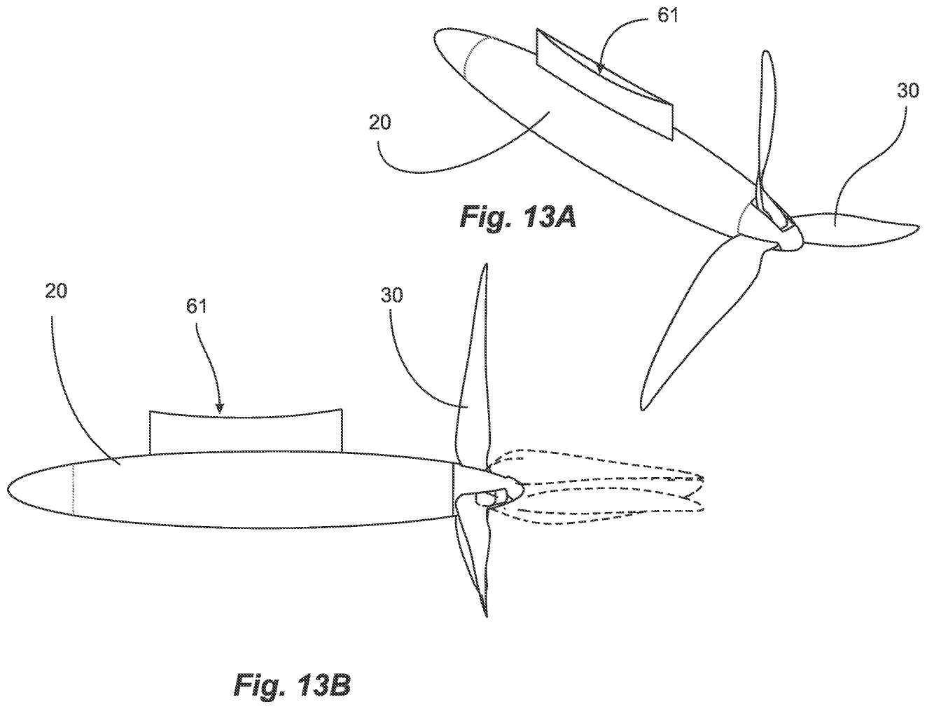

FIG. 13A is a perspective view of a pod 20 with propeller 30, and shows also a connecting fairing 61. FIG. 13B is a side view of the pod 20 of FIG. 13A pod with batteries, controller, motor and self-folding propeller 30, showing also the connecting fairing 61, which in some embodiments may contain and deploy parachute 60, seen in FIG. 10.

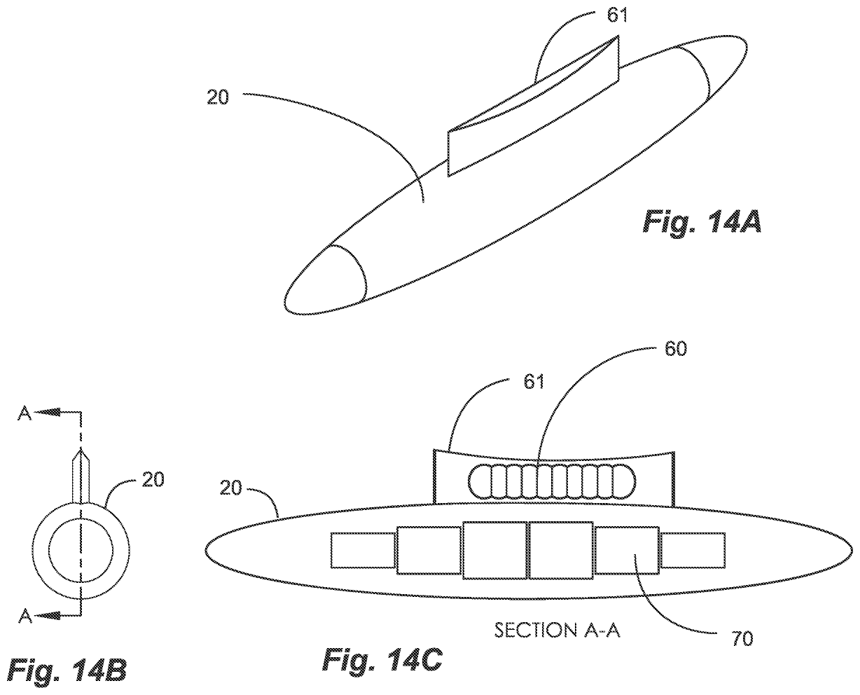

FIG. 14A is a perspective view of a pod 20 without propeller, with attachment fairing 61. FIG. 14B is a front view of pod 20 of FIG. 14A with a section line A-A indicated. FIG. 14C is a section view of the pod of FIGS. 14A and B, taken along section line A-A of FIG. 14B, showing fairing 61 sectioned and parachute 60, folded, within fairing 61. Section A-A also shows battery cells 70 within pod 20.

It is known in the art that aircraft batteries are electrically wired and connected in series, where the voltage load is distributed evenly or close top even. The problem with this scenario is that if one battery fails, or catches fire, none of the other batteries would operate and the aircraft would fail and cease to fly. In most embodiments of the present invention, the pods are wired and connected in parallel, wherein each pod, with battery, motor and propeller, can operate to fly the aircraft alone, without the assistance of another pod. In this embodiment, one pod is utilized to fly the plane until its charge is exhausted, for example after 45 minutes to one hour, and then it is jettisoned and the next pod is utilized to continue to fly the plane. Alternatively, two pods may be utilized at the same time, or even all of the available pods.

Although fire and safety are main advantages of implementing the present invention, additional advantages are that once a pod is ejected, weight on the overall plane is decreased, drag is decreased, thereby lessening the load wherein each remaining pod can keep the plane in the air a bit longer. Specific calculations for determining fight times v. weight of aircraft, drag, etc. are known in the art. Also, pods may be easily added or switched out for fresh, fully charged pods when the aircraft lands at a designated airport supporting such services.

In some embodiments GPS circuitry is included in pods, so pods may be quickly located and retrieved once having been jettisoned. In other embodiments there may be a homing signal produced by a jettisoned pod. As described briefly above, with the use of self-folding propellers, the propellers may be folded as a first step with a jettison sequence is activated, so the propellers may be less of a problem in descent and recovery of a pod.

The skilled person will understand that the descriptions herein are entirely, exemplary and are not strictly limiting to the scope of the invention. The scope is limited only by the claims.

What is claimed is:

1. An aircraft comprising:
a frame;
at least one electrically-powered propulsion unit providing motive power for levitation and translation of the aircraft;
at least one pod comprising a battery, mounted by a physical interface to the frame, the physical interface operable to detach and jettison the at last one pod, and comprising electrical connectors coupling the battery in the mounted pod to the at least one electrically-powered propulsion unit; and
control circuitry operable to manage power from the battery to the electrically-powered propulsion unit, and to jettison the pod.

2. The aircraft of claim 1 wherein the at least one pod comprises, in addition to the battery, local control circuitry, an electric motor and a propeller coupled to the motor such that, when the motor operates, the propeller spins.

3. The aircraft of claim 2 wherein the propeller is enabled to fold into a volume having an axis co-linear with an axis of the motor.

4. The aircraft of claim 2 wherein the propeller is enabled to vary pitch.

5. The aircraft of claim 1 wherein the aircraft is a fixed-wing aircraft, and pods are mounted beneath wings of the aircraft.

6. The aircraft of claim 5 wherein the pods mounted beneath the wings comprise controls, motors, and propellers, and are manageable through the control circuitry, individually, to start and stop the motors, fold the propellers, and to jettison the pods.

7. The aircraft of claim 6 wherein the pods further comprise each a parachute controllable to deploy following jettisoning the pod.

8. The aircraft of claim 5 wherein the fixed-wing aircraft further comprises an electrically-powered motor with propeller separate from the pods, powered from one of more of the pods.

9. The aircraft of claim 5 wherein the fixed-wing aircraft further comprises an internal combustion engine with propeller which is enabled to be stopped and feathered with pods powering motors with propellers in operation.
